(19) United States
(12) Patent Application Publication
(10) Pub. No.: US 2004/0221942 A1
(43) Pub. Date: Nov. 11, 2004

(54) Process for interlocking seam photoreceptor belt fabrication using adhesive tape with release substrate

(75) Inventors: Robert C.U. Yu, Webster, NY (US); Min-Hong Fu, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/434,927

(22) Filed: May 9, 2003

(51) Int. Cl. B32B 31/00

(52) U.S. Cl. 156/157; 156/304.3; 156/289; 156/309.6

(57) ABSTRACT

A process for adhesive bonding of an endless seamed flexible belt, wherein the belt has a first end and a second end, each of the first end and the second end with a plurality of mutually mating elements which join in an interlocking relationship to form a seam, and the seam has an adhesive, the process includes providing an adhesive strip on a front side of a release substrate to form an adhesive tape, wherein the release substrate includes polypropylene, vinyls, siloxane containing polymers, acrylates, polyimines, or mixtures thereof; providing the adhesive tape over the seam, wherein the front side of the release substrate containing the adhesive strip is in contact with the seam and mutually mating members; and subjecting the adhesive tape to adhesive bonding, wherein the adhesive strip melts and flows between the mutually mating members of the seam.

### CROSS REFERENCE TO RELATED APPLICATIONS

Attention is directed U.S. patent application Ser. No. 09/615,444 (D/99598), filed Jul. 13, 2000, entitled, “Polyimide Adhesive For Polyimide Component Interlocking Seams;” U.S. patent application Ser. No. 09/833,965 (D/A0895Q), filed Apr. 11, 2001, entitled, “Conductive Carbon Filled Polyvinyl Butyral Adhesive;” U.S. patent application Ser. No. 09/833,488 (D/A0895Q1), filed Apr. 11, 2001, entitled, “Dual Curing Process for Producing a Puzzle Cut Seam;” U.S. patent application Ser. No. 10/013,665 (A0896), filed Dec. 12, 2001, entitled, “Oxidized Transport Transfer Member Coatings;” U.S. patent application Ser. No. 09/833,964 (A1036) filed Apr. 11, 2001, entitled, “Flashless Hot Melt Bonding of Adhesives for Imageable Seamed Belts; U.S. patent application Ser. No. 09/833,546 (A0584) filed Apr. 11, 2001, entitled “Imageable Seamed Belts having Polyamide Adhesive Between Interlocking Seaming Members;” U.S. patent application Ser. No. 09/833,507 (A0584Q) filed Apr. 11, 2001, entitled “Polyamide and Conductive Filler Adhesive;” U.S. patent application Ser. No. 10/003,083 (A1640) filed Dec. 6, 2001, entitled “Imageable Seamed Belts having Polyamide and Doped Metal Oxide Adhesive Between Interlocking Seaming Members;” and U.S. patent application Ser. No. ______ (A1287) filed ______, entitled “Process for Interlocking Seam Belt Fabrication Using Adhesive Tape with Release Substrate.” The disclosures of each of these references are hereby incorporated by reference in their entirety.

### BACKGROUND OF THE INVENTION

The present invention is directed to processes for producing seamed belts useful as photoreceptors, electroreceptors, transfer members, including intermediate transfer members and other transfer members, and like members, useful in electrostatographic, including digital, apparatuses. In specific embodiments, the present invention is directed to seamed belts, and processes thereof, and more specifically, to endless seamed flexible belts wherein an image can be transferred at the seam of the belt with little or no print defects caused by the seam. In embodiments, the present invention relates to component imageable seamed belts comprising an adhesive formed between mutually mating elements of a seam. In embodiments, the seam is formed by placing an adhesive in the crevice between interlocking seaming members of the two belt ends. In further embodiments, the adhesive is present on a substrate. The invention further relates to adhesive tapes having a release substrate and adhesive layer on the release substrate. In embodiments, the substrate is selected from the group consisting of vinyls, polypropylenes, siloxane containing polymers, acrylates, polyimines, and mixtures thereof.

Electrophotographic imaging members, including photoreceptors or photoconductors, typically include a photoconductive layer formed on an electrically conductive substrate or formed on layers between the substrate and photoconductive layer. The photoconductive layer is an insulator in the dark, so that electric charges are retained on its surface. Upon exposure to light, the charge is dissipated, and an image can be formed thereon, developed using a developer material, transferred to a copy substrate, and fused thereto to form a copy or print.

Electrographic imaging members, including ionographic members or electrorecptors, are typically comprised of a supporting substrate layer and one imaging layer comprising thermoplastic polymeric matrix material. The “imaging layer” as employed herein, is defined as the dielectric imaging layer which is located in the upper portion of a cross section of the electrographic imaging member, while the supporting substrate layer is situated in the lower portion of the cross section of this imaging member.

Transfer of the toner image to a transfer member or other member results by use of a photoreceptor in the form of a seamed belt. In electrostatographic printing and photocopy machines in which the toner image is transferred from the photoreceptor to an image receiving member, it is desired that the transfer of the toner particles from the photoreceptor to the image receiving member be substantially 100 percent. Less than complete transfer to the image receiving member results in image degradation and low resolution. Complete transfer is particularly desirable when the imaging process involves generating full color images since undesirable color deterioration in the final colors can occur when the color images are not completely transferred from the photoreceptor.

Thus, it is desirable that the photoreceptor member surface has excellent release characteristics with respect to the toner particles. Conventional materials known in the art for use as photoreceptors often possess the strength, conformability and electrical conductivity necessary for use photoreceptor members, but can suffer from poor toner release characteristics, especially with respect to higher gloss image receiving substrates.

In the electrostatographic applications, use of a seamed photoreceptor member can result in insufficient transfer in that the developed image occurring on the seam is not adequately transferred. This incomplete transfer is partially the result of the difference in seam height to the rest of the belt. A “bump” is formed at the seam, created by overlapping the two opposite ends of a sheet to form a belt, thereby hindering toner image transfer and impacting mechanical performance. Moreover, excessive seam height of the photoreceptor belt is also found to be problematic, as it results in a nick in the elastomeric cleaning blade, causing premature cleaning failure and negatively impacting copy printout quality. The development of puzzle cut seams with matching, thickness and surface topology to the bulk of the photoreceptor belt, has increased the quality of image transfer somewhat, by decreasing the seam height and surface roughness, thereby allowing smooth belt cycling and ease of cleaning blade function during electrostatographic imaging and cleaning processes.

Attention is directed to the following patents, which may be relevant to this case.

U.S. Pat. No. 6,318,223 relates to a process and apparatus for producing an endless seamed belt.

U.S. Pat. No. 6,316,070 relates to unsaturated carbonate adhesives for component seams.

U.S. Pat. No. 6,379,486 relates to a process for seaming interlocking seams of polyimide component using polyimide adhesive.

U.S. Pat. No. 6,327,454 relates to imagable seamed belts having fluoropolymer adhesive between interlocking seaming members.

U.S. Pat. No. 6,387,465 relates to imagable seamed belts having fluoropolymer overcoat.

U.S. Pat. No. 6,358,347 relates to continuous process for manufacturing imagable seamed belts for printers.

U.S. Pat. No. 6,527,105 relates to imagable seamed belts having hot melt processable thermosetting resin and conductive carbon filler adhesive between interlocking seaming members.

Recent use of a polyamide adhesive has provided a seam which has abutted puzzle cut interlocking mechanism, no differential thickness, and smooth surface topology. This allows for seam area continuity in physical transition for overcoming many undesirable effects. Also, other types of adhesives can be used, which overcome previous problems. These adhesives include polyvinyl butyral (PVB), crosslinkable polyimides, and the like.

Use of adhesives in puzzle cut seaming techniques still has some problems, some of which relate to the adhesive tape substrate carrying the adhesive. In embodiments, some adhesive substrates do not readily separate from the adhesive after completing the heat/compression seam crevice filling process, and therefore, there is insufficient seam filling of the adhesive to effect strong adhesive bonding for desirable mechanical seam strength. Release problems can result from insufficient substrate surface energy lowering to facilitate release following high temperature/compression seam welding processes. In addition, some substrates carrying the adhesive do not have the ability to withstand processing temperatures of up to 120° C. or more without exhibiting material degradation. Further, some substrates cannot withstand temperature and compression force under impulse seam welding conditions. Further, problems result with some carrier substrates which tend to develop a blocking problem with the adhesive layer when a fabricated adhesive tape is wound into a roll-up webstock, because as adhesive layer is in intimate contact with the back surface of the carrier substrate. In embodiments wherein the adhesive tape is a dual-layer formulation consisting of an adhesive strip coated over a carrier substrate, it is desired that the carrier substrate be totally insoluble in the solvent or solvent mixture used for adhesive coating solution preparation. Further, in embodiments, the prepared adhesive tape webstock has reasonable physical flatness for ease of puzzle cut seam welding application. In embodiments, the fabricated adhesive tape webstock is then cut into strips that give a length, at least equal to the width of the seamed belt, and with a width, sufficiently enough to cover the puzzle cut seam, for effective seam welding operation.

Therefore, it is desired to provide an adhesive tape having a release substrate, wherein the release substrate easily separates from the adhesive after seam crevice filling. It is further desired to provide a release substrate with sufficient surface energy to facilitate release following seam-welding processes. Further, it is desired that the release substrate have the ability to withstand high temperatures of up to 120° C. or more without exhibiting material degradation. It is also desired to decrease or eliminate a blocking problem and to provide a reasonable flatness fabricated adhesive tape using the release substrate. Moreover, it is desired that the release substrate be insoluble in the solvent or solvent mixture used for adhesive coating solution preparation.

### SUMMARY OF THE INVENTION

Embodiments of the present invention include a process for adhesive bonding of a photoreceptor belt, wherein the photoreceptor belt comprises a seam comprising an adhesive, and wherein the photoreceptor comprises a photoreceptor substrate, charge transport layer comprising charge transport materials dispersed therein, and an overcoat layer, the process comprising a) providing an adhesive strip on a front side of a release substrate to form an adhesive tape, wherein the release substrate comprising a material selected from the group consisting of polypropylene, vinyls, siloxane containing polymers, acrylates, polyimines, and mixtures thereof; b) providing the adhesive tape over the seam, wherein the front side of the release substrate containing the adhesive strip is in contact with the seam and mutually mating members; and c) subjecting the adhesive tape to adhesive bonding, wherein the adhesive strip melts and flows between the mutually mating members of the seam.

In addition, embodiments of the present invention include a process for adhesive bonding of a photoreceptor belt, wherein the photoreceptor belt comprises a seam comprising an adhesive, and wherein the photoreceptor comprises a photoreceptor substrate, a hole-blocking layer capable of forming an electronic barrier to holes between the substrate and charge transport layer, a charge generating layer, a charge transport layer comprising charge transport materials dispersed therein, and an overcoat layer, the process comprising a) providing an adhesive strip on a front side of a release substrate to form an adhesive tape, wherein the release substrate comprises a material selected from the group consisting of polypropylene, vinyls, siloxane containing polymers, acrylates, polyimines, and mixtures thereof; b) providing the adhesive tape over the seam, wherein the front side of the release substrate containing the adhesive strip is in contact with the seam and mutually mating members; and c) subjecting the adhesive tape to adhesive bonding, wherein the adhesive strip melts and flows between the mutually mating members of the seam.

Embodiments further include a process for adhesive bonding of a photoreceptor belt, wherein the photoreceptor belt comprises a seam comprising an adhesive, and wherein the photoreceptor comprises a photoreceptor substrate, charge transport layer comprising charge transport materials dispersed therein, and an overcoat layer, the process comprising a) providing an polyamide adhesive strip on a front side of a release substrate to form an adhesive tape, wherein the release substrate comprises a material selected from the group consisting of polypropylene, vinyls, siloxane containing polymers, acrylates, polyimines, and mixtures thereof; b) providing the adhesive tape over the seam, wherein the front side of the release substrate containing the polyamide adhesive strip is in contact with the seam and mutually mating members; and c) subjecting the adhesive tape to adhesive bonding, wherein the polyamide adhesive strip melts and flows between the mutually mating members of the seam.

### BRIEF DESCRIPTION OF THE DRAWINGS

For a better understanding of the present invention, reference may be had to the accompanying figures.

FIG. 1 is a depiction of an electrostatographic apparatus.

FIG. 2 is an embodiment of the invention and is an enlarged version of a cross-sectional view of a photoreceptor belt.

FIG. 3 is an enhanced view of an embodiment of a belt configuration and seam according to the present invention.

FIG. 4 is an enlargement of a puzzle cut seam having a multiplicity of head and neck members according to one embodiment of the present invention.

FIG. 5 is an enlargement of a puzzle cut seam having mushroom-shaped puzzle cut members according to another embodiment of the present invention.

FIG. 6 is an enlargement of a puzzle cut seam having dovetail members according to another embodiment of the present invention.

FIG. 7 is an enlargement of a puzzle cut seam having receptacles (recessors) and teeth members according to another embodiment of the present invention.

FIG. 8 is an enlargement of a puzzle cut seam having receptacle and projection members of differing depth according to another embodiment of the present invention.

FIG. 9 is an enlarged version of a belt according to one embodiment of the present invention and demonstrates a puzzle cut seam having adhesive between interlocking puzzle cut or mutually mating seaming members.

FIG. 10 is an enlarged cross section of a seam having puzzle cut seaming members, and having an adhesive between interlocking seaming members.

FIG. 11 is an enlarged side view of a release substrate having an adhesive strip thereon.

### DETAILED DESCRIPTION OF THE PRESENT INVENTION

The present invention relates to an endless flexible seamed belt having mutually mating seaming members, wherein the seam comprises an adhesive. In embodiments, the process for bonding the seam comprises placing an adhesive in a crevice between seaming members, and in embodiments, interlocking and mated seaming members. The adhesive is present on a release substrate to form an adhesive tape, and the release substrate with adhesive is placed over the seam for filling and bonding of the seam. In embodiments, the release substrate is selected from the group consisting of polyethylene terephthalate, polyethylene, polypropylene, ethylene chlorotrifluoroethylene, ethylene tetrafluoroethylene, polyvinylidene fluoride, polyvinyl fluoride, siloxane containing polymers, fluorinated acrylate polymers, fluorinated methacrylate polymers, polyimines, and the like, and mixtures thereof. In embodiments, the adhesive is polyamide, polyvinylbutyral, crosslinkable polyimide, and the like. In embodiments, the belt is a photoreceptor belt.

In embodiments, the release substrates provide easy releasing or separating from the adhesive after completing the seam filling process. Therefore, there is ease of separation following subjecting the tape to elevated temperature/compression seam crevice filling and bonding processes. In addition, the release substrates have the ability to withstand processing temperatures of up to 120° C. or more, without exhibiting material degradation. The release substrates, in embodiments, possess good functional mechanical integrity to withstand temperature and compression force under impulse seam welding conditions. The release substrates, in embodiments, provide improved release ability in order to prevent a blocking problem, such as adhesive in intimate contact with the back surface of the substrate in a roll-up webstock. Therefore, the release substrate selected for adhesive tape fabrication can have a surface energy of 28 dynes/cm or less, or from about 15 to about 28 dynes/cm, or about 17 dynes/cm.

In embodiments, the belt can be in the form of a belt, sheet, roller, drelt (a hybrid of a drum and a belt), or film useful in xerographic, including digital, apparatuses. The belts herein using the release substrate may be useful for many different processes and components such as photoreceptors, ionographic imaging members, fusing members, transfix members, bias transfer members, bias charging members, developer members, image bearing members, conveyor members, cleaning members, and other members for contact electrostatic printing applications, xerographic applications, including digital, and the like. Further, the belts, herein, can be used for both liquid and dry powder xerographic architectures.

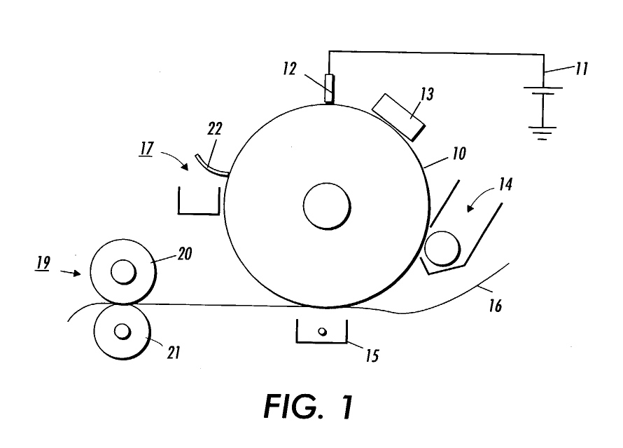

Referring to FIG. 1, in a typical electrostatographic reproducing apparatus, a light image of an original to be copied is recorded in the form of an electrostatic latent image upon a photosensitive member and the latent image is subsequently rendered visible by the application of electroscopic thermoplastic resin particles which are commonly referred to as toner. Specifically, drelt (consisting of a seamed photoreceptor belt mounted over and encircling a rigid drum) photoreceptor 10 is charged on its surface by means of an electrical charger 12 to which a voltage has been supplied from power supply 11. The photoreceptor is then imagewise exposed to light from an optical system or an image input apparatus 13, such as a laser and light emitting diode, to form an electrostatic latent image thereon. Generally, the electrostatic latent image is developed by bringing a developer mixture from developer station 14 into contact therewith. Development can be effected by use of a magnetic brush, powder cloud, or other known development process.

After the toner particles have been deposited on the photoconductive surface, in image configuration, they are transferred to a copy sheet 16 by transfer means 15, which can be pressure transfer or electrostatic transfer. In embodiments, the developed image can be transferred to an intermediate transfer member and subsequently transferred to a copy sheet.

After the transfer of the developed image is completed, copy sheet 16 advances to fusing station 19, depicted in FIG. 1 as fusing and pressure rolls, wherein the developed image is fused to copy sheet 16 by passing copy sheet 16 between the fusing member 20 and pressure member 21, thereby forming a permanent image. Fusing may be accomplished by other fusing members such as a fusing belt in pressure contact with a pressure roller, fusing roller in contact with a pressure belt, or other like systems. Drelt photoreceptor 10, subsequent to transfer, advances to cleaning station 17, wherein any toner left on the surface of drelt photoreceptor 10 is cleaned therefrom by use of a blade 22 (as shown in FIG. 1), brush, or other cleaning apparatus.

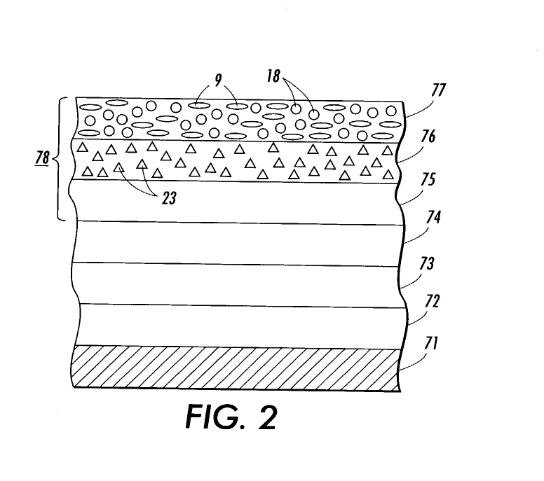

In embodiments, the belt is a photoreceptor. Photoreceptors can be of many different configurations, for example, they can be seamed or seamless belts. An example of an embodiment of a negatively charged photoreceptor is given in FIG. 2. Referring to FIG. 2, typically, a flexible substrate 71 is provided with an electrically conductive surface or coating 72.

An optional hole-blocking layer 73 may be applied to the coating 72. Any suitable and conventional blocking layer capable of forming an electronic barrier to prevent injection of holes between the adjacent photoconductive layer 78 (or electrophotographic imaging layer 78) and the underlying conductive surface 72 of substrate 71 may be used. An adhesive layer 74, if needed to promote adhesion, may be positioned on the hole-blocking layer 73.

At least one electrophotographic imaging layer 78 is formed on the adhesive layer 74. The electrophotographic imaging layer 78 may be a single layer that performs both charge-generating and charge transport functions as is well known in the art, or it may comprise multiple layers such as a charge generator layer 75, charge transport layer 76, and overcoat 77 according to FIG. 2. Overcoat 77 may contain fillers 9 and 18, which may be the same or different.

The charge-generating layer 75 can be applied to the electrically conductive surface, or on other surfaces in between the substrate 71 and charge-generating layer 75. A charge-blocking layer or hole-blocking layer 73 may optionally be applied to the electrically conductive surface prior to the application of a charge-generating layer 75. If desired, an adhesive layer 74 may be used between the charge blocking or hole-blocking layer 73 and the charge generating layer 75. Usually, the charge generation layer 75 is directly applied onto the blocking layer 73 if adhesion is not a problem, and a charge transport layer 76 is formed on the charge generation layer 75.

Any suitable polymeric film forming binder material may be employed as the matrix in the charge-generating (photogenerating) binder layer such as thermoplastic and thermosetting resins, for example, polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrenebutadiene copolymers, vinylidenechloride-vinylchloride copolymers, vinylacetate-vinylidenechloride copolymers, styrene-alkyd resins, polyvinylcarbazole, and the like.

The charge transport layer 76 may comprise a charge transporting small molecules 23 dissolved or molecularly dispersed in a film forming electrically inert polymer such as a polycarbonate. Typical charge transporting small molecules include, for example, pyrazolines such as 1-phenyl-3-(4′-diethylamino styryl)-5-(4″-diethylamino phenyl)pyrazoline, diamines such as N,N′-diphenyl-N,N′-bis(3-methylphenyl)-(1,1′-biphenyl)-4,4′-diamine, hydrazones such as N-phenyl-N-methyl-3-(9-ethyl)carbazyl hydrazone and 4-diethyl amino benzaldehyde-1,2-diphenyl hydrazone, and oxadiazoles such as 2,5-bis(4-N,N′-diethylaminophenyl)-1,2,4-oxadiazole, stilbenes and the like.

Any suitable electrically inactive resin binder insoluble in the alcohol solvent used to apply the overcoat layer 77 may be employed in the charge transport layer of this invention. Typical inactive resin binders include polycarbonate resin (such as poly(4,4′-isopropylidene-diphenylene)carbonate (also referred to as bisphenol-A-polycarbonate, poly(4,4′-cyclohexylidinediphenylene) carbonate (referred to as bisphenol-Z polycarbonate), poly(4,4′-isopropylidene-3,3′-dimethyl-diphenyl) carbonate (also referred to as bisphenol-C-polycarbonate) and the like), polyester, polyarylate, polyacrylate, polyether, polysulfone, and the like.

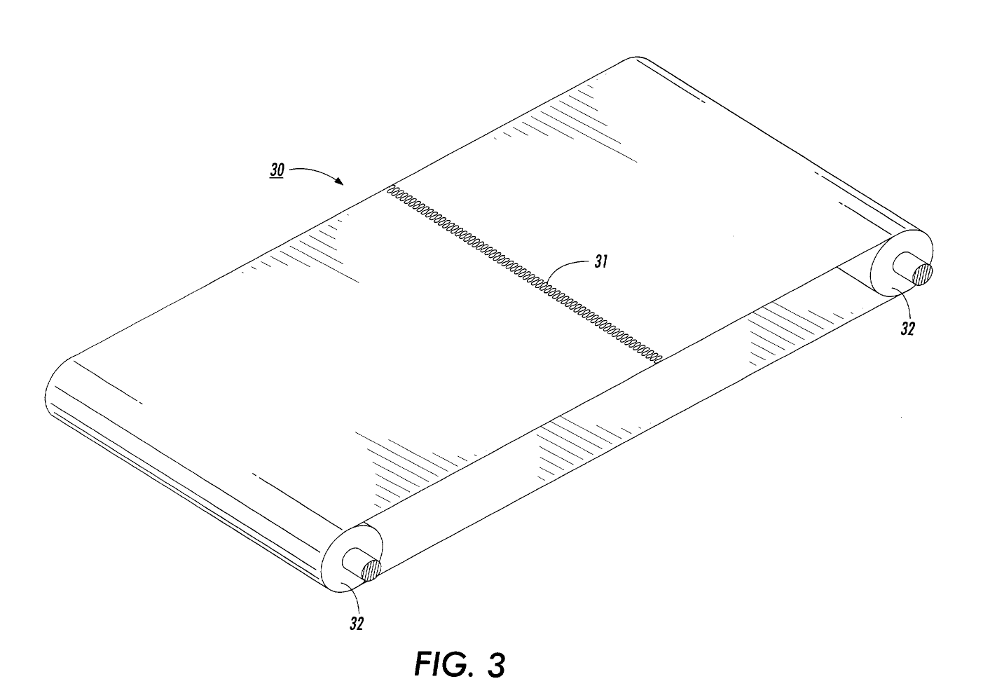

FIG. 3 demonstrates an example of an embodiment of a belt in accordance with the present invention. Belt 30 is demonstrated with seam 31. Seam 31 is pictured as an example of one embodiment of a puzzle cut seam. The belt is held in position and turned by use of rollers 32. Note that the mechanical interlocking relationship of the seam 31 is present in a two-dimensional plane when the belt 30 is on a flat surface, whether it be horizontal or vertical. While the seam is illustrated in FIG. 3 as being perpendicular to the two parallel sides of the belt, it should be understood that it may be angled or slanted with respect to the parallel sides. This enables any noise generated in the system to be distributed more uniformly and the forces placed on each mating element or node to be reduced.

The seam formed according to the present invention is one having a thin and smooth profile, of enhanced strength, improved flexibility and extended mechanical life. In an embodiment, the belt ends are held together by the geometric relationship between the ends of the belt material, which are mated and fastened together by a puzzle cut. The puzzle cut seam can be of many different configurations, but is one in which the two ends of the seam interlock with one another in a manner of a puzzle. Specifically, the mutually mating elements comprise a first projection and a second receptacle geometrically oriented so that the second receptacle on the first end receives the first projection on the second end and wherein the first projection on the first end is received by the second receptacle on the second end. The seam has a kerf, void or crevice between the mutually mating elements at the two joining ends of the belt, and that crevice can be filled with an adhesive according to the present invention. The opposite surfaces of the puzzle cut pattern are bound or joined together to enable the seamed flexible belt to essentially function as an endless belt. In the present invention, the seam including the puzzle cut members, is held together and bonded by a polyamide adhesive, which is compatible with the rest of the belt. The belt, in embodiments, provides improved seam quality and smoothness with substantially no thickness differential between the seam and the adjacent portions of the belt.

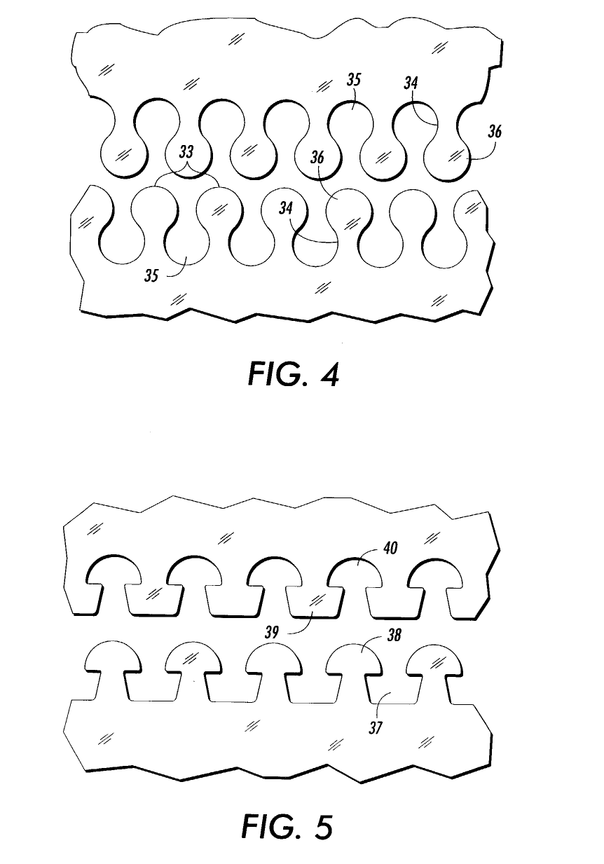

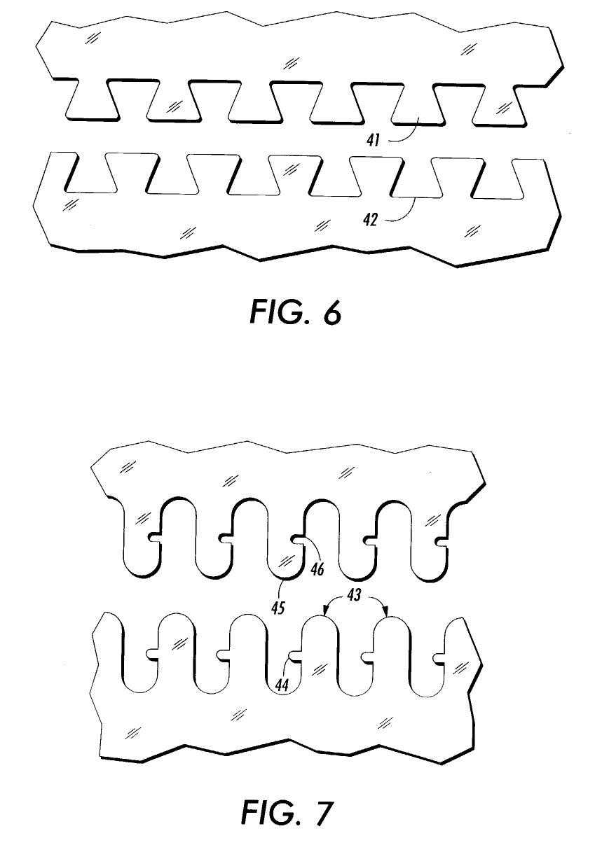

An example of an embodiment of a puzzle cut seam having two ends, each of the ends comprising puzzle cut members or mutually mating elements is shown in FIG. 4. The puzzle cut pattern may take virtually any form, including that of nodes such as identical post or neck 34 and head 33 or node patterns having projections 36 and receptacles 35 which interlock when brought together as illustrated in FIG. 4. The puzzle cut pattern may also be of a more mushroom-like shaped pattern having first projections 38 and 39 and second receptacles 40 and 37 as illustrated in FIG. 5, as well as a dovetail pattern as illustrated in FIG. 6 having first projections 41 and second receptacles 42. The puzzle cut pattern illustrated in FIG. 7 has a plurality of first fingers 43 with interlocking teeth 44 and plurality of second fingers 45 which have recesses 46 to interlock with the teeth 44 when assembled. In embodiments, the interlocking elements all have curved mating elements to reduce the stress between the interlocking elements and permit them to separate when traveling around curved members such as the rolls 32 of FIG. 3. It has been found that with curved mating elements that the stress is lower than with square corners where rather than the stress being uniformly distributed it is concentrated leading to possible failure.

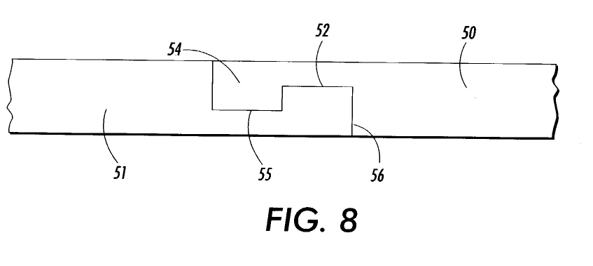

Another example of a puzzle cut seam is shown in FIG. 8 in which the mutually mating elements or puzzle cut members comprise a first member 50 and a second member 51, wherein the first member 50 comprises a first receptacle 52 and a first projection 54, and the second member 51 comprises a second receptacle 55 and a second projection 56. The first receptacle 52 of the first member 50 receives the second projection 56 of the second member 51, and the second receptacle 55 of the second member 51 receives the first projection 54 of the first member 50. In order to reduce or eliminate the height differential between the seamed portion and the adjacent, unseamed portion of the belt, it is desirable to have the first and second projection and receptacle mating pairs formed within their individual members which are shaped to have proper matching dimensions in a portion of the belt as the belt ends.

In embodiments, the height differential between the seam and the rest of the belt (the nonseamed portions of the belt) is practically nil, or from about 0 to about 15 micrometers, or from about 0.0001 to about 25 micrometers, or from about 0.01 to about 5 micrometers.

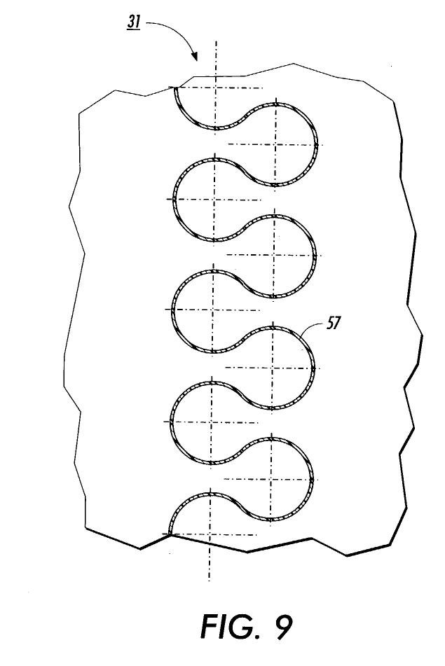

An adhesive is present between the seaming members, and placed in the crevice between the puzzle cut members to a thickness or dimension of from about 0.001 to about 50 micrometers. As shown in one embodiment of a puzzle cut seam 31 according to the present invention, the adhesive is present between the puzzle cut members and at the seam crevice 57 of FIG. 9.

Examples of suitable adhesives include polyamide resins, polyvinyl butyral, crosslinkable polyimides, and the like. In embodiments, a polyamide resin is used as the adhesive. The polyamide resin can be alcohol-soluble. By “alcohol-soluble,” Applicants refer to materials, which dissolve in alcohols such as butanol, ethanol, methanol and the like. In embodiments, the polyamide resin in the adhesive has functional pendant groups selected from the group consisting of methoxy, ethoxy and hydroxy pendant groups. In embodiments, the pendant functional group is a methoxy methylene group. In embodiments, the polyamide has the following formula:

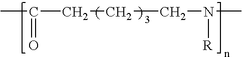

wherein n is a number of from about 50 to about 1,000, or from about 150 to about 500, or about 270, and wherein R is selected from the group consisting of hydrogen; alkyl having from about 1 to about 20 carbons, or from about 1 to about 10 carbons, such as methyl, ethyl, propyl and the like; alkoxy having from about 1 to about 20 carbons, or from about 1 to about 10 carbons such as methoxy, ethoxy, propoxy and the like; alkyl alkoxy having from about 1 to about 20 carbons, or from about 1 to about 10 carbons such as methyl methoxy, methyl ethoxy, ethyl methoxy, methyl dimethoxy, methyl trimethoxy, and the like; and alkylene alkoxy having from about 1 to about 20 carbons, or from about 1 to about 10 carbons such as methylene methoxy, ethylene ethoxy, and the like. In embodiments, monomers of the above formula can be included in an adhesive composition, wherein R in the monomers can be hydrogen, methylene methoxy, and methylene dimethoxy, or R in the adhesive composition can be from about 40 to about 80 mole percent hydrogen, or from about 50 to about 65 mole percent hydrogen, or about 64 mole percent hydrogen; and from about 20 to about 45 mole percent methylene methoxy, or from about 30 to about 35 mole percent methylene methoxy, or about 32 mole percent methylene methoxy; and from about 1 to about 10 mole percent methylene dimethoxy, or from about 1 to about 5 mole percent methylene dimethoxy, or about 4 mole percent methylene dimethoxy. Typical commercially available alcohol-soluble polyamide polymers suitable for use herein include those sold under the tradenames LUCKAMIDE® 5003 from Dai Nippon Ink, NYLON® 8, CM4000® and CM8000® both from Toray Industries, Ltd., and other N-methylene methoxy pendant polyamides such as those prepared according to the method described in Sorenson and Campbell, “Preparative Methods of Polymer Chemistry,” second edition, pg. 76, John Wiley & Sons, Inc., 1968, and the like, and mixtures thereof.

A suitable, fine powder, conductivity-enhancing filler that is uniformly dispersed without large agglomerates, can be used with the adhesive. In embodiments, the filler can be a carbon filler, metal oxide filler, doped metal oxide filler, polymer filler, charge transporting molecules, or the like, or mixtures thereof. Examples of doped metal oxide fillers include aluminum-doped zinc oxide (ZnO), antimony doped titanium dioxide (TiO₃), antimony doped tin oxide, similar doped oxides, and mixtures thereof. Other conductive fillers include silicon powder, quaternary salts such as quaternary ammonium salts (for examples Adogen 464 sold by Aldrich Chemical as methyltrialkyl (C₈-C₁₀) ammonium chloride), and pyrolyzed polyacrylonitrile particles and fibers.

Examples of carbon fillers include carbon black, graphite, fluorinated carbon, or mixtures thereof. Specific examples of fluorinated carbons include those having the formula CFₓ with x representing the number of fluorine atoms and generally being up to about 1.5, or from about 0.01 to about 1.5, or from about 0.04 to about 1.4. Other examples of fluorinated carbons are poly(dicarbon monofluoride) which is usually written in the shorthand manner (C₂F)ₙ. Examples of fluorinated carbons selected include those described in U.S. Pat. No. 4,524,119 to Luly et al., the subject matter of which is hereby incorporated by reference in its entirety, and those having the tradename ACCUFLUOR®, (fluorinated carbons from Advanced Research Chemicals, Inc., Catoosa, Okla.). Examples include ACCUFLUOR® 2028, ACCUFLUOR® 2065, ACCUFLUOR® 1000, and ACCUFLUOR® 2010. ACCUFLUOR® 2028 and ACCUFLUOR® 2010 have 28 and 11 percent by weight fluorine, respectively, based on the weight of fluorinated carbon. ACCUFLUOR® 1000 and ACCUFLUOR® 2065 have 62 and 65 percent by weight fluorine, respectively, based on the weight of fluorinated carbon. Also, ACCUFLUOR® 1000 comprises carbon coke, whereas ACCUFLUOR® 2065, 2028 and 2010 all comprise conductive carbon black. These fluorinated carbons are of the formula CFₓ and are formed by the reaction of C+F₂=CFₓ.

Examples of metal oxide fillers include titanium dioxide, tin (II) oxide, aluminum oxide, indium-tin oxide, magnesium oxide, copper oxide, iron oxide, and the like, and mixtures thereof.

Examples of polymer fillers include polypyrrole, polyacrylonitrile (for example, pyrolyzed polyacrylonitrile), polyaniline, polythiophenes, and mixtures thereof.

Examples of charge transporting molecules include bis(dihydroxy diethylamino-)triphenyl methane (DHTPM), bis(diethylamino)triphenyl methane (TPM), dihydroxy tetraphenyl biphenylene diamine (DHTBD), and the like, and mixtures thereof. In embodiments, the charge transporting molecules include DHTPM and DHTBD.

In embodiments, the filler(s) is/are present in the adhesive in a total amount of from about 1 to about 80, or from about 20 to about 50 percent by weight of total solids. Total solids, as used herein, refers to the amount of adhesive polymer resin, filler(s), crosslinking agent, other additives, and other solids present in the adhesive.

Crosslinking agents can be used in combination with the adhesive to promote crosslinking of the polymer, thereby providing a strong bond. Examples of suitable crosslinking agents include oxalic acid, p-toluene sulfonic acid, phosphoric acid, sulfuric acid, and the like, and mixtures thereof. In embodiments, the adhesive is a polyamide resin, and the crosslinking agent is oxalic acid.

The adhesive solution may be applied at the seam using a release substrate. An amount of adhesive in slight excess of the amount required to completely fill the seam kerf when dry, is placed on the release substrate, and the substrate is placed over the seam. The release substrate is then made to flow in the crevice between interlocking seaming members. For example, the release substrate is placed over the seam, and the adhesive is melted into the seam kerf under applied temperature and pressure. Continued heating allows the resin to crosslink.

In general, the process for seaming using the adhesive herein involves preparation of the adhesive tape webstock by compounding the adhesive resin, optionally with a filler(s). This is followed by forming a coating solution of the adhesive formulation, and then applying the coating solution onto a selected release substrate webstock (which may be 100 feet in length). Drying the liquid-phase composite wet coating (in embodiments, at an elevated temperature), into a solid phase, thin layer, adhesive strip or film is the next phase. Crosslinking agents such as oxalic acid can be used and can be added into the adhesive formulation during coating solution preparation. The fabricated adhesive tape containing the release substrate and adhesive, is then placed and positioned directly over the seam so that the adhesive is facing and aligns with the interlocked seamed region of the belt. The mating members may be vacuum held down over a lower jaw of an impulse welder. The upper jaw of the welder can then be brought down to make contact with the back side of the release substrate of the adhesive tape to provide heating/compression force effecting adhesive melting and flowing into the crevice to complete the process of bonding the seam. Curing of the seam can be accomplished using thermal compression or impulse welding. The release substrate can them be removed from the adhesive bonded seam which can then be post seam cured by various methods.

The seam can then be post cured by various methods. Curing procedures useful in curing the seam include room temperature moisture curing, thermal curing, infrared curing, CO₂ laser curing, and the like. In embodiments, the second cure cycle is at a temperature higher than the first cure cycle. Temperatures for the first cure range from about 40 to about 150° C., or from about 40 to about 120° C., for a time of from about 30 seconds to about 30 minutes, or from about 1 minute to about 1 hour. Temperatures for the second cure range from about 120 to about 200° C., or from about 150 to about 180° C., at a time of from about 30 seconds to about 30 minutes, or from about 10 minutes to about 1 hour.

This moderate heating for adhesive curing also increases the crosslinking/solidification reaction and increases the seam processing and belt fabrication speed. After completing the adhesive curing cycles, the release substrate is easily removed from the adhesive to give a bonded seam. The resulting seam is then subjected to a final super-finishing seam polished process to remove residual adhesive material from the seam surface and give a topologically smooth puzzle cut seamed belt having little or no differential thickness.

The release substrate comprises a material that provides easy releasing or separating of the adhesive from the release substrate following the seam filling process. Therefore, the substrate chosen for adhesive tape fabrication can have a surface energy of 28 dynes/cm or less, or from about 15 to about 28 dynes/cm, or about 17 dynes/cm in order to meet the ease of substrate releasing requirement. In addition, the release substrates have the ability to withstand processing temperatures of up to 120° C. or more without exhibiting material degradation. The release substrates, in embodiments, possess good functional mechanical integrity to withstand temperature and compression force under impulse seam welding conditions. The release substrates, in embodiments, provide improved release ability in order to prevent a blocking problem, such as having non-sticky adhesive contact with the back surface of the substrate in a roll-up webstock.

Examples of suitable release substrates include those materials selected from the group consisting of polypropylene, vinyls, siloxane containing polymers, acrylates, polyimines, and mixtures thereof. Specific examples include polyethylene terephthalate including surface treated polyethylene terephthalate, polyethylene such as waxy polyethylene, polypropylene, ethylene chlorotrifluoroethylene, ethylene tetrafluoroethylene, polyvinylidene fluoride, polyvinyl fluoride, siloxane containing polymers, poly(styrene-stat-2,2,3,3-tetrafluoropropyl methacrylate), poly(heptafluoroisopropyl acrylate), poly(heptafluoroisopropyl methacrylate), fluorinated acrylates, fluorinated methacrylates, polyimines, and the like, and mixtures thereof. Commercial examples of suitable release substrate materials include PET Melinex 516/360, HALAR®, TEFZEL®, KYNAR®, TEDLAR®, siloxane surface treated polyester, and the like.

In embodiments, the preparation of an adhesive tape webstock is carried out by dissolving a selected adhesive resin (such as a polyamide) and an electrically active compound (such as DHTBD), optionally with a small quantity of filler dispersion (such as carbon black), in a solvent to form a coating solution. Crosslinking agents such as oxalic acid may also be used and added into the adhesive formulation during coating solution preparation. The formulated adhesive solution, in embodiments, is then applied onto a selected release substrate webstock, and followed by drying the liquid-phase composite wet coating, at elevated temperature, for example, of 40° C. for about 5 hours, into a solid phase thin adhesive layer, to give the adhesive tape. Since the adhesive layer is solution coated over the release substrate, it does (after drying) provide reasonably adhesion bonding to the release substrate. Therefore, the dried adhesive layer being in contact with the back surface of release substrate in a fabricated roll-up webstock (in embodiments) is readily released when the adhesive tape is unwound for seam welding application.

In embodiments, the wet adhesive is coated on the release substrate and is heated and dried, so as to bond the adhesive to the release substrate at a temperature of from about 10 to about 75° C., or from about 20 to about 40° C., at a time of from about 1 to about 10 hours, or from about 3 to about 5 hours to form the adhesive tape webstock.

In embodiments, the release substrate has a thickness of from about 1 to about 10 mils, or from about 1 to about 5 mils, or from about 2 to about 3 mils.

In embodiments, the width of the release substrate is determined by or relative to the width of the adhesive strip employed. For example, in embodiments, the width of the release substrate is greater than the width of the adhesive strip. In embodiments, the width of the release substrate is from about 0.5 to about 20 millimeters, or from about 1 to about 10 millimeters, or from about 3 to about 6 mm wider than the width of the adhesive strip. Similarly, the release substrate can have a width of from about 1 to about 5 times greater than a width of the adhesive strip, or from about 2 to about 3 times greater than a width of the adhesive strip. This allows for a decrease or elimination of flashing of excess adhesive from the edges of the seam.

In embodiments, the adhesive strip has a width of from about 0.5 to about 10 mm, or from about 1.5 to about 5 mm, or from about 2.5 to about 4 mm. In embodiments, the thickness of the adhesive is from about 10 to about 125 micrometers, or from about 60 to about 80 micrometers.

In embodiments, the dimensions of width and thickness of the adhesive strip are selected such that there is sufficient adhesive available to fully cover the seam area and adequately fill the kerf gap in the seam.

In embodiments, the release substrate has a length similar or longer than that of the belt seam, and a width that is larger than that of the belt seam. In embodiments, the adhesive strip has a length similar or longer than that of the belt seam and with a width at least sufficiently adequate to cover the width of the seam.

The width of the adhesive is usually chosen to be about the same or slightly wider than the seam area. The adhesive will soften and flow or spread when heat and/or pressure are applied. A narrow strip of adhesive of sufficient thickness could be used to effectively cover a wider area.

The width of the seam, or the distance between the base of the mutually mating elements, is from about 0.5 to about 10 millimeters, or from about 1 to about 5 millimeters.

The width of the seam crevice, the distance measured between mutually mating elements created by the void, is from about 0.0001 to about 50 micrometers, or from about 5 to about 25 micrometers.

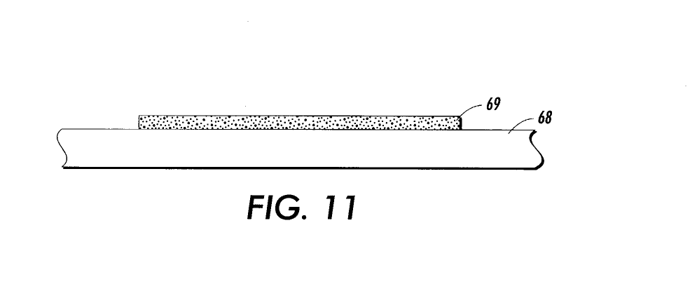

FIG. 11 shows an example of a fabricated adhesive tape comprising an adhesive 69 placed on a release substrate 68.

The puzzle cut seamed belt comprises a substrate that is robust enough to undergo multiple cycling through rigorous use. Examples of suitable substrate materials, especially for intermediate transfer members, include polyimides with or without conductive fillers, such as semiconductive polyimides, for example, polyaniline polyimide, carbon filled polyimides, carbon filled polycarbonate, and the like. Examples of commercially available polyimide substrates include KAPTON® and UPLIEX® both from DuPont, and ULTEM® from GE.

Other examples of suitable belt substrate materials, especially in the case of a photoreceptor, include polyesters, polycarbonates, polyamides, polyurethanes, and the like which are flexible as thin webs. An electrically conducting substrate may be any metal, for example, aluminum, nickel, steel, copper, and the like or a polymeric material, as described above.

The belt substrate may include a filler. In embodiments, the filler, if present in the substrate, is present in an amount of from about 1 to about 60, or from about 3 to about 40 percent by weight of total solids. Examples of suitable fillers for use in the substrate include carbon fillers, metal oxide fillers, doped metal oxide fillers, other metal fillers, other conductive fillers, and the like. Specific examples of fillers include carbon fillers such as carbon black, silicon particles, fluorinated carbon black, graphite, low conductive carbon, and the like, and mixtures thereof; metal oxides such as indium tin oxide, zinc oxide, iron oxide, aluminum oxide, copper oxide, lead oxide, and the like, and mixtures thereof; doped metal oxides such as antimony-doped tin oxide, antimony-doped titanium dioxide, aluminum-doped zinc oxide, similar doped metal oxides, and mixtures thereof; and polymer particles such as polytetrafluoroethylene, polypyrrole, polyaniline, doped polyaniline, and the like, and mixtures thereof.

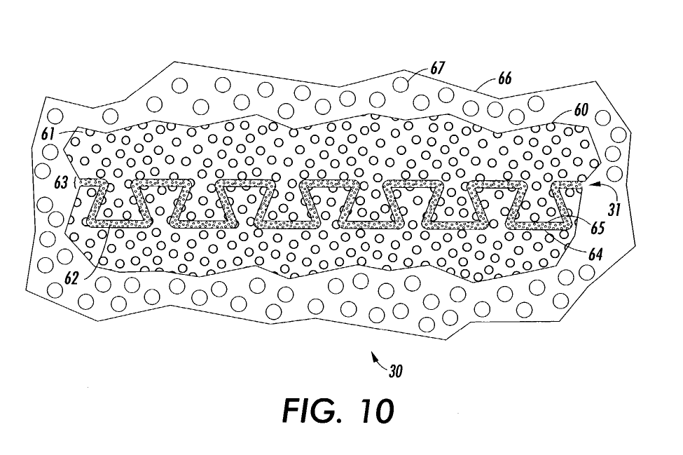

An example of a belt used in combination with the adhesive is depicted in FIG. 10. The belt 30 comprises a substrate 66, having therein, in embodiments, conductive fillers 67. The belt contains seam 31 having a crevice, and having an adhesive layer 60 positioned over the seam area and between members 64 and 65, thereby filling the crevice of seam 31. In an embodiment, conductive fillers 62 are dispersed or contained in the adhesive filling 63 inside 31. Conductive fillers 67 optionally dispersed or contained in the belt substrate and fillers 62 in the adhesive 63 that fills the crevice of seam 31 and fillers 61 optionally contained or dispersed in the adhesive, may be the same or different.

All the patents and applications referred to herein are hereby specifically, and totally incorporated herein by reference in their entirety in the instant specification.

The following Examples further define and describe embodiments of the present invention. Unless otherwise indicated, all parts and percentages are by weight.

### EXAMPLES

### Example 1

Preparation of Adhesive Strip over Release Substrate to Bond an Intermediate Transfer Belt Seam

A photoreceptor belt of a material structure as defined in FIG. 2 and having an interlocking seam was fabricated as described below.

An adhesive coating solution of a polyamide (LUCKAMIDE®) was prepared. The wet adhesive coating layer or strip was applied over a selected 2 or 3-mil release substrate. The applied wet adhesive strip over the substrate was subsequently dried at 40° C. for about 5 hours. The result was an adhesive tape 80 microns thick. The fabricated tape was then cut into a 4 mm wide strip, and placed over a mated puzzle cut joint. This was followed by 120° C. heating and compression process for 10 minutes, using an impulse welder, in order to fill the seam crevice and bond the seam into a photoreceptor belt. The puzzle cut seam of the fabricated belt was subjected to a final super-finished polishing process to remove seam surface adhesive residual to thereby give a resulting photoreceptor belt having a smooth seam topology and with little or no added thickness. The adhesive tape preparation was carried out by webstock coating process.

### Example 2

Preparation of PolVamide Adhesive on Various Release Substrates

Seven test samples having polyamide adhesive on various release substrates were prepared. The substrates were as follows: 1) slip agent pretreated PET (polyethylene terephthalate) Melinex 516/360 (3-mil thick), 2) ultra high molecular weight waxy polyethylene (3-mil thick) having at least 500,000 weight average molecular weight, 3) polypropylene (3-mil thick), 4) ethylene-chlorotrifluoroethylene (HALAR®) (3-mil thick), 5) ethylene-tetrafluoroethylene (TEFZEL®) (3-mil thick), 6) polyvinylidene fluoride (KYNAR®) (3-mil thick),and 7) polyvinyl fluoride (TEDLAR®) (2-mil thick).

Each of the above substrates was coated with a polyamide (LUCKAMIDE®) solution consisting of 14.7 grams polyamide, 14.7 grams DHTBD, 0.961 grams trioxane, 0.961 grams oxalic acid and 0.147 grams carbon black (Black Pearls® 2000) dissolved in 47.25 grams equal parts methanol/n-propanol solvent mix.

The applied adhesive coating was then dried at 40° C. for about 5 hours to rid the solvent and form the adhesive tape having good coating thickness and uniformity, and with good webstock flatness.

Each of the polyamide adhesive tapes obtained was then cut to give 4 mm wide strips and each was used for photoreceptor belt mutually mating (or puzzle cut joint having a 30-micron crevice) seam belt preparation through compression and 120° C. temperature process for 60 minutes, simulating the impulse welder seaming conditions, to fill the seam crevice and complete the adhesive crosslinking reaction as well. After the seam welding simulation, all of is the above listed substrates were found to be easily released from the adhesive filled seam without encountering any problem. The puzzle cut seam of each fabricated belt thus obtained was finally subjected to a super-finished polishing process to remove adhesive residual residing on the surface, which thereby gives a resulting seam having smooth topology and virtually nil differential thickness.

### Example 3

Preparation of Polyvinyl Fluoride Release Substrate with Polyamide Adhesive

The above polyvinyl fluoride (TEDLAR®) (2-mil thick) release substrate carrying the polyamide adhesive strip prepared in accordance with Example 2, was tested after superfinishing. The substrate carrying the adhesive strip was used to seam an photoreceptor belt in accordance with the procedures carried out in Example 2. The polyvinyl fluoride release substrate with polyamide adhesive was found to have good seam strength uniformity of about 35 pounds/inch (obtained from 3 test seam samples).

While the invention has been described in detail with reference to specific and in embodiments, it will be appreciated that various modifications and variations will be apparent to the artisan. All such modifications and embodiments as may readily occur to one skilled in the art are intended to be within the scope of the appended claims.

We claim:

1. A process for adhesive bonding of a photoreceptor belt, wherein the photoreceptor belt comprises a seam comprising an adhesive, and wherein the photoreceptor comprises a photoreceptor substrate, charge transport layer comprising charge transport materials dispersed therein, and an overcoat layer, the process comprising:
a) providing an adhesive strip on a front side of a release substrate to form an adhesive tape, wherein the release substrate comprising a material selected from the group consisting of polypropylene, vinyls, siloxane containing polymers, acrylates, polyimines, and mixtures thereof;
b) providing the adhesive tape over the seam, wherein the front side of the release substrate containing the adhesive strip is in contact with the seam and mutually mating members; and
c) subjecting the adhesive tape to adhesive bonding, wherein the adhesive strip melts and flows between the mutually mating members of the seam.

2. A process for adhesive bonding of a photoreceptor belt in accordance with claim 1, wherein the release substrate material is selected from the group consisting of polyethylene, polyethylene terephthalate, ethylene chlorotrifluoroethylene, ethylene tetrafluoroethylene, polyvinylidene fluoride, polyvinyl fluoride, poly(styrene-stat-2,2,3,3-tetrafluoropropyl methacrylate), poly(heptafluoroisopropyl acrylate), poly(heptafluoroisopropyl methacrylate), fluorinated acrylate polymers, fluorinated methacrylate polymers, and mixtures thereof.

3. A process for adhesive bonding of a photoreceptor belt in accordance with claim 1, wherein the release substrate has a thickness of from about 1 to about 10 mils.

4. A process for adhesive bonding of a photoreceptor belt in accordance with claim 3, wherein the release substrate has a thickness of from about 1 to about 5 mils.

5. A process for adhesive bonding of a photoreceptor belt in accordance with claim 1, wherein the release substrate has a surface energy of about 28 dynes/cm or less.

6. A process for adhesive bonding of a photoreceptor belt in accordance with claim 5, wherein the release substrate has a surface energy of from about 15 to about 28 dynes/cm.

7. A process for adhesive bonding of a photoreceptor belt in accordance with claim 1, wherein in a), the adhesive strip is provided on a front side of the release substrate, followed by drying the adhesive strip on the release substrate so as to dry and bond the adhesive strip to the release substrate to form the adhesive tape.

8. A process for adhesive bonding of a photoreceptor belt in accordance with claim 7, wherein the drying is accomplished at a temperature of from about 10 to about 75° C.

9. A process for adhesive bonding of a photoreceptor belt in accordance with claim 7, wherein the drying is accomplished at a time of from about 1 to about 10 hours.

10. A process for adhesive bonding of a photoreceptor belt in accordance with claim 1, wherein in c) the adhesive bonding is accomplished using thermal compression molding or impulse welding.

11. A process for adhesive bonding of a photoreceptor belt in accordance with claim 1, further comprising after c), d) removing the release substrate from the adhesive strip.

12. A process for adhesive bonding of a photoreceptor belt in accordance with claim 11, further comprising after d), e) subjecting the seam to superfinishing.

13. A process for adhesive bonding of a photoreceptor belt in accordance with claim 1, wherein the adhesive is selected from the group consisting of polyamide, polyvinyl butyral, crosslinkable polyimides, and mixtures thereof.

14. A process for adhesive bonding of a photoreceptor belt in accordance with claim 13, wherein the adhesive comprises an alcohol-soluble polyamide.

15. A process for adhesive bonding of a photoreceptor belt in accordance with claim 13, wherein the polyamide has the following general formula: 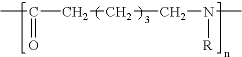
wherein R is selected from the group consisting of hydrogen, alkyl having from about 1 to about 20 carbons, alkoxy having from about 1 to about 20 carbons, alkyl alkoxy having from about 1 to about 20 carbons, and alkylene alkoxy having from about 1 to about 20 carbons, and wherein n is a number of from about 50 to about 1,000.

16. A process for adhesive bonding of a photoreceptor belt in accordance with claim 15, wherein R is a methylene methoxy group.

17. A process for adhesive bonding of a photoreceptor belt in accordance with claim 1, wherein the adhesive is crosslinked.

18. A process for adhesive bonding of a photoreceptor belt in accordance with claim 1, wherein positioned between the photoreceptor substrate and the charge transport layer is a hole-blocking layer capable of forming an electronic barrier to holes transporting between the substrate and charge transport layer.

19. A process for adhesive bonding of a photoreceptor belt in accordance with claim 18, wherein positioned between the hole-blocking layer and the charge transport layer is a charge generating layer.

20. A process for adhesive bonding of a photoreceptor belt, wherein the photoreceptor belt comprises a seam comprising an adhesive, and wherein the photoreceptor comprises a photoreceptor substrate, a hole-blocking layer capable of forming an electronic barrier to holes between the substrate and charge transport layer, a charge generating layer, a charge transport layer comprising charge transport materials dispersed therein, and an overcoat layer, the process comprising:
a) providing an adhesive strip on a front side of a release substrate to form an adhesive tape, wherein the release substrate comprises a material selected from the group consisting of polypropylene, vinyls, siloxane containing polymers, acrylates, polyimines, and mixtures thereof;
b) providing the adhesive tape over the seam, wherein the front side of the release substrate containing the adhesive strip is in contact with the seam and mutually mating members; and
c) subjecting the adhesive tape to adhesive bonding, wherein the adhesive strip melts and flows between the mutually mating members of the seam.

21. A process for adhesive bonding of a photoreceptor belt, wherein the photoreceptor belt comprises a seam comprising an adhesive, and wherein the photoreceptor comprises a photoreceptor substrate, charge transport layer comprising charge transport materials dispersed therein, and an overcoat layer, the process comprising:
a) providing an polyamide adhesive strip on a front side of a release substrate to form an adhesive tape, wherein the release substrate comprises a material selected from the group consisting of polypropylene, vinyls, siloxane containing polymers, acrylates, polyimines, and mixtures thereof;
b) providing the adhesive tape over the seam, wherein the front side of the release substrate containing the polyamide adhesive strip is in contact with the seam and mutually mating members; and
c) subjecting the adhesive tape to adhesive bonding, wherein the polyamide adhesive strip melts and flows between the mutually mating members of the seam.
